(19) United States
(12) Patent Application Publication
(10) Pub. No.: US 2025/0294452 A1
(43) Pub. Date: Sep. 18, 2025

(54) SYSTEMS AND METHODS FOR INVALIDATION SIGNALING

(71) Applicant: TELEFONAKTIEBOLAGET LM ERICSSON (PUBL), STOCKHOLM (SE)

(72) Inventors: Ilmiawan Shubhi, Lund (SE); Rui Fan, Beijing (CN); Ali Nader, Lund (SE); Andres Reial, Lund (SE); Sina Maleki, Lund (SE)

(21) Appl. No.: 18/861,443

(22) PCT Filed: Apr. 29, 2023
(86) PCT No.: PCT/IB2023/054482

§ 371 Date: Oct. 29, 2024

(30) Foreign Application Priority Data
Apr. 29, 2022 (WO) PCT/CN2022/090763

(51) Int. Cl. H04W 52/02

(52) U.S. Cl. CPC H04W 52/0225

(57) ABSTRACT

Systems and methods for invalidation signaling between wireless devices and network nodes for refraining them from performing at least part of activities thereof are provided. A method in a wireless device may include invalidating an activity of the wireless device in response to an invalidation configuration being configured for invalidating an activity of the wireless device. A method in a network node may include informing to a wireless device an invalidation configuration for invalidating an activity of the wireless device.

### RELATED APPLICATIONS

This application claims the benefit of PCT patent application serial number PCT/CN2022/090763, filed Apr. 29, 2022, the disclosure of which is hereby incorporated herein by reference in its entirety.

### TECHNICAL FIELD

The present disclosure relates to invalidation signaling between wireless devices and network nodes for refraining them from performing at least part of activities thereof.

### BACKGROUND

The network power consumption for 3rd Generation Partnership Project (3GPP) New Radio (NR) is said to be less compared to Long Term Evolution (LTE) because of its lean design. In the current implementation, however, NR will most likely consume more power compared to LTE, e.g., due to the higher bandwidth and more so due tom the introduction of additional elements such as 64 transmit (TX)/receive (RX) ports with associated digital radio frequency (RF) chains. As the network is expected to be able to support the UE with its maximum capability (e.g., throughput, coverage, etc.), the network may need to use full configuration even when the maximum network support is rarely needed by the User Equipments (UEs).

An increased number of TX/RX ports, for example, may lead to an increase in the number of reference signals (e.g., Channel State Information Reference Signals (CSI-RSs)) needed to be received and measured by the UE for proper data transmission. For a certain duration of time, however, some of these CSI-RSs, may not be needed. For example, when the network only serves a relatively low load or traffic of Ues which only requires relatively low throughput. In this case, those Ues may not need to do some frequent CSI-RS measurements or may not need to do CSI-RS measurements, at least, for a certain duration of time. In addition, a larger number of CSI-RS transmissions also results in an increase in the number of reports that need to be sent by the UE to the network. To accommodate such a large number of reports, the network may need to always stay awake and be ready to receive the reports. As a consequence, this may reduce the possibility for the network to sleep and save power. Furthermore, a large number of reports may also indirectly consume network resources in particular for Time Division Duplexing (TDD) operation. When the number of reports is relatively large, the network may need to allocate a larger number of slots for uplink (UL) in one TDD pattern.

Furthermore, despite the lean design, the network still needs to perform additional operations between two Synchronization Signal Block (SSB) transmissions, which prevents the network from going to deeper sleep modes, e.g., the transmission of periodic Tracking Reference Signal (TRS)/CSI-RS, transmission of downlink (DL) such as Physical Downlink Control Channel (PDCCH) or Physical Downlink Shared Channel (PDSCH), or listening to UE UL channels such as Physical Random Access Channel (PRACH), Physical Uplink Control Channel (PUCCH), and Physical Uplink Shared Channel (PUSCH).

When it comes to SSB transmissions, depending on the deployment, there could be multiple SSBs transmitted by the next generation NodeB (gNB) within a cell on a periodic basis. For example, for cells deployed on carriers below 3 Gigahertz (GHz), up to 4 SSBs may be transmitted. For cells deployed on carriers between 3 GHz and 6 GHz, there could be up to 8 SSBs transmitted, and the corresponding maximum number for carriers above 6 GHz is 64 SSBs. The gNB informs Ues, via broadcast system information block 1 (SIB1), of the number of SSBs and which SSBs are transmitted within the cell via the parameter ssb-PositionsInBurst. This parameter consists of two 8-bit wide bitmaps called inOneGroup and groupPresence. The 8 bits in inOneGroup specify which SSBs are being transmitted. For cells deployed on carriers above 6 GHz, the 64 SSBs are divided into 8 groups identified by groupPresence.

### SUMMARY

Systems and methods for invalidating an activity of a wireless device in a wireless network are disclosed. In one embodiment, a method in a wireless device comprises receiving a signal explicitly indicating an invalidation configuration for invalidating an activity of the wireless device, or receiving a defined configuration implying the invalidation configuration. The method further comprises invalidating the activity of the wireless device in response to the invalidation configuration. In this manner, the wireless devices is enabled to invalidate at least part of its activities, such as unnecessary measurements, signal monitoring, reporting, and other transmissions, and thus save power.

In one embodiment, the invalidation configuration is related to at least one of: periodic or semi-persistent reference signals in downlink and/or uplink, periodic or semi-persistent grant, Physical Downlink Control Channel (PDCCH) Monitoring (MO), search space for scheduling PDCCH, Physical Random Access Channel (PRACH) access resources, Physical Uplink Control Channel (PUCCH)/Physical Uplink Shared Channel (PUSCH) resources, Synchronization Signal Block (SSB), System Information Block (SIB), and scheduling requests.

In one embodiment, the activity comprises at least one of: reception of periodic or semi-persistent downlink reference signals, transmission of periodic or semi-persistent uplink reference signals, measurement of reference signals, reception of scheduling PDCCH, transmission of a periodic or semi-persistent reference signal report, reception of periodic or semi-persistent uplink grants and/or downlink assignments, transmission of a scheduling request, transmission of a preamble on a PRACH, reception of either a group or individual SSB, reception of a System Information Block (SIB), PUCCH transmission, and Physical Downlink Shared Channel (PDSCH) reception.

In one embodiment, the invalidation configuration comprises an invalidation duration in which the wireless device refrains from performing the activity, or a reference to one of a set of preconfigured invalidation durations as the invalidation duration, and invalidating the activity of the wireless device comprises refraining from performing the activity for a period of time according to the invalidation duration. In one embodiment, the invalidation duration is represented by a preconfigured value in unit of time or by a relative value which is a multiple of a specific time length, or is numerology dependent or independent. In one embodiment, the invalidation duration is defined per activity, or per channel, or per transmission direction, or per SSB, or per signal, or per cell, and the method further comprises, before invalidating the activity of the wireless device, determining whether the invalidation duration is defined for the activity. In addition, invalidating the activity of the wireless device comprises, if it is determined that the invalidation duration is defined for the activity, refraining from performing the activity for a period of time with respect to a channel, or a transmission direction, or an SSB, or a signal, or a cell according to the invalidation duration. In one embodiment, the invalidation configuration comprises a reference to one of a set of preconfigured invalidation durations as the invalidation duration, the wireless device is informed of the set of preconfigured invalidation durations via a first signaling, and then the wireless device is informed of the one of the set of preconfigured invalidation durations is the invalidation duration to be currently applied via a second signaling.

In one embodiment, the invalidation configuration comprises an invalidation pattern or a reference to one of a set of preconfigured patterns, which indicates a pattern in which the wireless device is to invalidate the activity, and invalidating the activity of the wireless device comprises refraining from performing the activity according to the invalidation pattern. In one embodiment, the invalidation pattern indicates when the wireless device remains performing the activity, or when the wireless device refrains from performing the activity. In one embodiment, the invalidation pattern indicates a periodicity configured for the activity, and invalidating the activity of the wireless device comprises refraining from performing the activity in a periodic manner according to the periodicity. In one embodiment, the periodicity is configured as a predefined value in unit of time, or as an integer value which is multiplied with a specific periodicity. In one embodiment, the periodicity configured in the invalidation pattern overwrites a periodicity originally configured for the activity. In one embodiment, the invalidation configuration comprises a duration of time configured to define how long the invalidation pattern should be applied to the activity, and invalidating the activity of the wireless device comprises, refraining from performing the activity according to the invalidation pattern for the configured duration of time.

In one embodiment, the invalidation configuration comprises one or more formats defined through higher layer signaling.

In one embodiment, the one or more formats are defined as device specific, group-common, or cell specific, and/or the one or more formats are defined the same or different for different activities, signals, channels, or operations, and invalidating the activity of the wireless device comprises refraining from performing the activity according to the one or more formats.

In one embodiment, the invalidation configuration is configured for specific instances of a recurrent transmission.

In one embodiment, the invalidation configuration is in a form of ssb-PositionsInBurst, called invalidSsb-PositionsInBurst, pointing out one or more instances of SSBs that are invalidated, or an update to content of SSBperiodicity or SSBtomeasure without a need for a system information (SI) update or Radio Resource Control (RRC) reconfiguration.

In one embodiment, the format is a Downlink Control Information (DCI) format or a Medium Access Control Layer-Control Element (MAC-CE) format.

In one embodiment, the invalidation configuration comprises a number of bits that are used in an invalidation signaling bitfield. In one embodiment, the invalidation configuration comprises a length, a location, or a size of the invalidation signaling bitfield in a DCI format. In one embodiment, the number of bits includes a predefined value, or is based on a number of durations or patterns included in the invalidation configuration.

In one embodiment, the invalidation configuration comprises a codepoint representation including one or more codepoints for representing whether there is invalidation configuration or not, or the invalidation durations or patterns. In one embodiment, the number of codepoints is based on a number of durations or patterns included in the invalidation configuration.

In one embodiment, the invalidation configuration comprises one or more codepoints for representing activities or instances of transmission within an activity to be invalidated.

In one embodiment, the invalidation configuration is configured and transmitted through broadcast channel or system information.

In one embodiment, the invalidation configuration comprises a timing indication indicating a timing to apply activity invalidation, and invalidating the activity of the wireless device comprises refraining from performing the activity at the timing indicated by the timing indication. In one embodiment, refraining from performing the activity at the timing indicated by the timing indication comprises refraining from performing the activity directly after receiving the invalidation configuration or refraining from performing the activity at a symbol which is at least P symbols or Q slots after the last symbol of a PDCCH containing the invalidation configuration, wherein the values of P and Q are preconfigured, or based on numerology, or configured based on a processing capability of the wireless device. In one embodiment, the timing indication is configured differently per activity, per operation, per channel, per cell, per Bandwidth Part (BWP) or per band. In one embodiment, the timing indication is configured based on a specific reference time in relation to the invalidation configuration.

In one embodiment, the invalidation configuration is configured in a periodic manner, and invalidating the activity of the wireless device comprises refraining from performing the activity periodically according to the invalidation configuration. In one embodiment, a period of the invalidation configuration comprises an invalidation interval and a non-invalidation interval defined by one or more offsets from a beginning of a specific period.

In one embodiment, the method further comprises resuming the activity of the wireless device in response to a cancellation configuration being configured for canceling the invalidation configuration and resuming the activity. In one embodiment, the cancellation configuration is represented by a codepoint included in the invalidation configuration, or is configured in a same or different manner as the invalidation configuration; and/or resuming the activity of the wireless device comprises resuming the activity of the wireless device after a predetermined or configured application delay from when the wireless device receives the cancellation configuration.

In one embodiment, the method further comprises controlling counting operations of one or more timers included in the wireless device in response to the invalidation configuration being configured.

Corresponding embodiments of a wireless device are also disclosed. In one embodiment, a wireless device comprises one or more processors and memory storing instructions that, when executed by the one or more processors, cause the wireless device to invalidate an activity of the wireless device in response to an invalidation configuration being configured for invalidating an activity of the wireless device.

Embodiments of a method in a network node are also disclosed. In one embodiment, a method in a network node comprises sending to a wireless device an invalidation configuration for invalidating an activity of the wireless device.

In one embodiment, the method further comprises configuring the invalidation configuration.

In one embodiment, sending the invalidation configuration comprises: transmitting a signal explicitly indicating the invalidation configuration, or transmitting a defined configuration implying the invalidation configuration.

In one embodiment, the method further comprises refraining from performing an activity of the network node corresponding to the activity of the wireless device in accordance with the invalidation configuration.

In one embodiment, the method further comprises sending to the wireless device a cancellation configuration for canceling the invalidation configuration and resuming the activity, and resuming the activity of the network node according to the cancellation configuration.

Corresponding embodiments of a network node are also disclosed. In one embodiment, a network node comprises one or more processors and memory storing instructions that, when executed by the one or more processors, cause the network node to send to a wireless device an invalidation configuration for invalidating an activity of the wireless device.

### BRIEF DESCRIPTION OF THE DRAWING

The accompanying drawing figures incorporated in and forming a part of this specification illustrate several aspects of the disclosure, and together with the description serve to explain the principles of the disclosure.

FIG. 1 is a schematic block diagram of a wireless device according to some embodiments of the present disclosure;

FIG. 2 is a schematic block diagram of a network node according to some embodiments of the present disclosure;

FIG. 3 is a flowchart illustrating a method performed by a wireless device according to some embodiments of the present disclosure;

FIG. 4 is a flowchart illustrating a method performed by a network node according to some embodiments of the present disclosure;

FIG. 5 shows an example of an invalidation signaling via Downlink Control Information (DCI) for periodic Channel State Information Reference Signal (CSI-RS) and Channel State Information (CSI) report transmission/reception;

FIG. 6 shows an example of invalidation signaling with invalidation signaling cancelation via DCI;

FIG. 7 shows an example of a communication system in accordance with some embodiments;

FIG. 8 shows a User Equipment (UE) in accordance with some embodiments;

FIG. 9 shows a network node in accordance with some embodiments;

FIG. 10 is a block diagram of a host, which may be an embodiment of the host of FIG. 7, in accordance with various aspects described herein;

FIG. 11 is a block diagram illustrating a virtualization environment in which functions implemented by some embodiments may be virtualized; and

FIG. 12 shows a communication diagram of a host communicating via a network node with a UE over a partially wireless connection in accordance with some embodiments.

### DETAILED DESCRIPTION

Some of the embodiments contemplated herein will now be described more fully with reference to the accompanying drawings. Embodiments are provided by way of example to convey the scope of the subject matter to those skilled in the art.

Radio Node: As used herein, a “radio node” is either a radio access node or a wireless communication device.

Radio Access Node: As used herein, a “radio access node” or “radio network node” or “radio access network node” is any node in a radio access network of a cellular communications network that operates to wirelessly transmit and/or receive signals. Some examples of a radio access node include, but are not limited to, a base station (e.g., a New Radio (NR) base station (referred to as a next generation NodeB (gNB)) in a 3rd Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit or a network node that implements a gNB Distributed Unit) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing a Access and Mobility Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: A wireless communication device is also referred to herein as a “wireless device.” One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the radio access network or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Herein, the term “invalidation,” “invalidate” and “invalidating” may means omitting an activity or refraining a wireless device or a network node from performing an activity for a period of time.

Note that, in the description herein, reference may be made to the term “cell”; however, particularly with respect to 5G NR concepts, beams may be used instead of cells and, as such, it is important to note that the concepts described herein are equally applicable to both cells and beams. Sector is another term that is sometimes also used to represent a cell.

There currently exist certain challenge(s). When a UE is configured with reference signals such as Synchronization Signal Blocks (SSBs) or Channel State Information Reference Signals (CSI-RSs) (in particular for a periodic or semi-persistent CSI-RS), the network needs to transmit and the UE needs to measure those reference signals and transmit a report although the UE may not need it, e.g., as the UE does not expect to receive or transmit data for a certain duration of time. In addition, it may also be that some scheduling can be conducted either in a sparser manner or can be delayed until a certain duration ahead (e.g., several/tens milliseconds (ms)).

For idle mode UEs, in case the network wants to deactivate a certain SSB transmission, the UEs need to be informed about the change. Such changes may only be done via system information update, which is a lengthy process discouraging the network from dynamically turning on/off certain SSB transmissions.

Configuring the UE with only aperiodic activities will be a problem when there is a lot of traffic, and the UE needs to keep updating its report as it consumes resources. Configuring with only periodic will be inefficient when there is low or medium traffic.

Therefore, a method to enable invalidating at least some activities (for example, transmission/reception activities, e.g., periodic or semi-persistent CSI-RS, SSBs, PUCCH transmission, etc.) for the network and the UE may be required to save their power.

Certain aspects of the disclosure and their embodiments may provide solutions to these or other challenges. Systems and methods for invalidation signaling between wireless devices and network nodes for refraining them from performing at least part of activities thereof are provided.

In some embodiments, a method in a wireless device is provided. The method may include invalidating an activity of the wireless device in response to an invalidation configuration being configured for invalidating an activity of the wireless device.

In some embodiments, a method in a network node is provided. The method may include informing to a wireless device an invalidation configuration for invalidating an activity of the wireless device.

In some embodiments, a wireless device may include one or more processors, and memory storing instructions that, when executed by the one or more processors, cause the wireless device to perform a method. The method may include invalidating an activity of the wireless device in response to an invalidation configuration being configured for invalidating an activity of the wireless device.

In some embodiments, a network node may include one or more processors, and memory storing instructions that, when executed by the one or more processors, cause the network node to perform a method. The method may include informing to a wireless device an invalidation configuration for invalidating an activity of the wireless device.

Certain embodiments may provide one or more of the following technical advantage(s). With the solutions provided in the present disclosure, network nodes and wireless devices are enabled to invalidate at least part of their activities, such as unnecessary measurements, signal monitoring, reporting, and other transmissions, and thus save power. Network nodes and wireless devices may also improve resource utilization by, for example, optimizing PDSCH and/or PUSCH transmission. These, in the end, will increase possibility for network nodes and wireless devices to gain more sleep time and save power. In the uplink (UL) direction, as a result of wireless device's transmission cancellations, the network nodes may create reception gaps during which they can reduce receiver-related activities, for example, utilizing various sleep states depending on gap length, and thereby save energy.

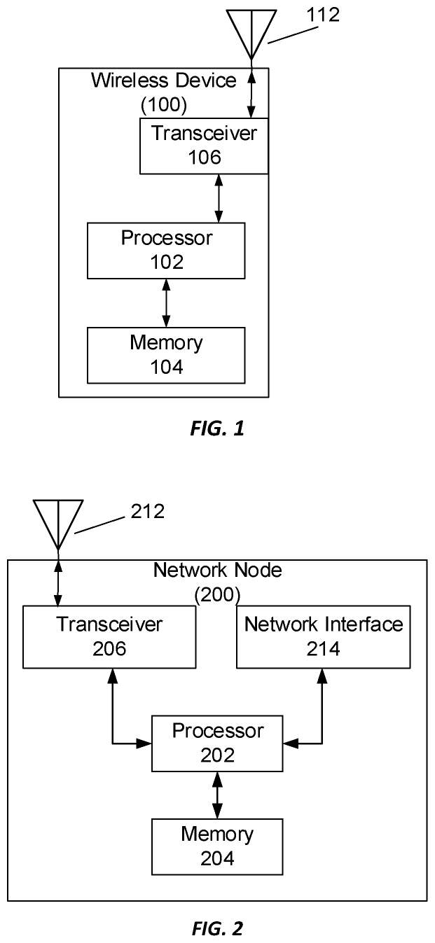

FIG. 1 is a schematic block diagram of a wireless device according to some embodiments of the present disclosure. As illustrated, the wireless device 100 includes one or more processors 102 (e.g., Central Processing Units (CPUs), Application Specific Integrated Circuits (ASICs), Field Programmable Gate Arrays (FPGAs), and/or the like), memory 104, and one or more transceivers 106 each including one or more transmitters and one or more receivers coupled to one or more antennas 112. The transceiver(s) 106 includes radio-front end circuitry connected to the antenna(s) 112 that is configured to condition signals communicated between the antenna(s) 112 and the processor(s) 102, as will be appreciated by one of ordinary skill in the art. The processors 102 are also referred to herein as processing circuitry. The transceivers 106 are also referred to herein as radio circuitry. In some embodiments, the functionality of the wireless device 100 described herein may be fully or partially implemented in software that is, e.g., stored in the memory 104 and executed by the processor(s) 102. Note that the wireless communication device 100 may include additional components not illustrated in FIG. 1 such as, e.g., one or more user interface components (e.g., an input/output interface including a display, buttons, a touch screen, a microphone, a speaker(s), and/or the like and/or any other components for allowing input of information into the wireless device 100 and/or allowing output of information from the wireless device 100), a power supply (e.g., a battery and associated power circuitry), etc.

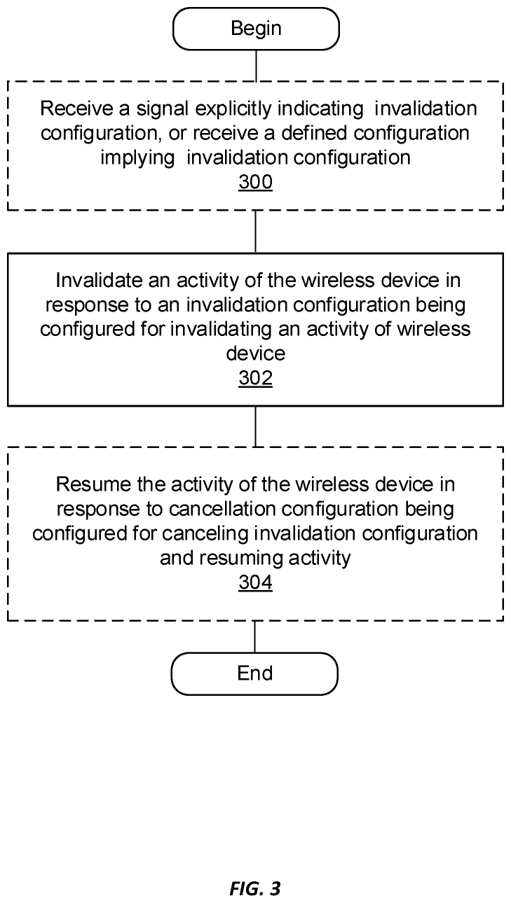

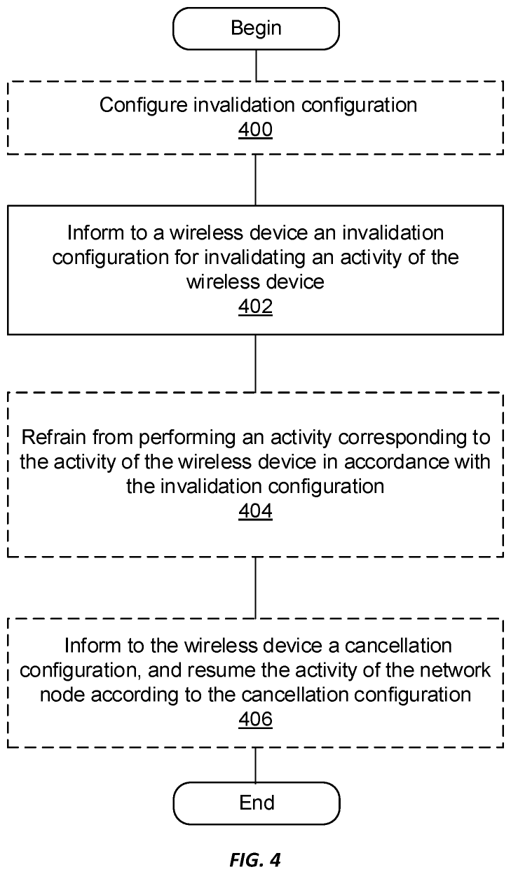

In some embodiments, a computer program is provided to include instructions which, when executed by at least one processor, causes the at least one processor to carry out the functionality of the wireless device 100 according to any of the embodiments described herein, for example, one or more of the steps included in a method shown in FIG. 3 to be described later. In some embodiments, a carrier comprising the aforementioned computer program product is provided. The carrier is one of an electronic signal, an optical signal, a radio signal, or a computer readable storage medium (e.g., a non-transitory computer readable medium such as memory).

In some embodiments, the wireless device 100 may include one or more modules, each of which is implemented in software. The module(s) provide the functionality of the wireless device 100 according to any of the embodiments described herein.

FIG. 2 is a schematic block diagram of a network node according to some embodiments of the present disclosure. As illustrated, the network node 200 includes one or more processors 202 (e.g., CPUs, ASICs, FPGAs, and/or the like), memory 204, one or more transceivers 206 each including one or more transmitters and one or more receivers coupled to one or more antennas 212, and network interface 214. The transceiver(s) 206 includes radio-front end circuitry connected to the antenna(s) 212 that is configured to condition signals communicated between the antenna(s) 212 and the processor(s) 202, as will be appreciated by one of ordinary skill in the art. The processors 202 are also referred to herein as processing circuitry. The transceivers 206 are also referred to herein as radio circuitry. The network interface 214 may be configured to provide communications with other network nodes and/or core network. In some embodiments, the functionality of the network node 200 described herein may be fully or partially implemented in software that is, e.g., stored in the memory 204 and executed by the processor(s) 202. Note that the network node 200 may include additional components not illustrated in FIG. 2, such as a power supply and associated power circuitry, etc.

In some embodiments, a computer program is provided to include instructions which, when executed by at least one processor, causes the at least one processor to carry out the functionality of the network node 200 according to any of the embodiments described herein, for example, one or more of the steps included in methods shown in FIG. 4 to be described later. In some embodiments, a carrier comprising the aforementioned computer program product is provided. The carrier is one of an electronic signal, an optical signal, a radio signal, or a computer readable storage medium (e.g., a non-transitory computer readable medium such as memory).

In some embodiments, the network node 200 includes one or more modules, each of which is implemented in software. The module(s) provide the functionality of the network node 200 according to any of the embodiments described herein.

It may be beneficent to omit unnecessary activities or conduct some scheduling in a sparser or delayed manner for network nodes and wireless devices to save power and improve resource utilization. Systems and methods for invalidation signaling between wireless devices and network nodes for refraining them from performing at least part of activities thereof are provided herein. Specifically, a network node (e.g., network node 200) may transmit signaling to a wireless device (e.g., wireless device 100) that informs the wireless device to invalidate (e.g., omit or delay) some of its activities, e.g., transmission activities and/or measurements or other signal monitoring. Some of the activities may include:
-Periodic SSB measurements,
Periodic SIB reception,
On-demand SIB reception,
PDCCH monitoring,
Periodic or semi-persistent CSI-RS measurements,
CSI-RS reporting,
Periodic or semi-persistent grant,
Scheduling request (SR),
Random Access attempts (RA),
PUSCH occasions/transmission, and
the like.

When the wireless device is configured with invalidation, the network node may correspondingly invalidate some of its activities, such as transmitting related RS (e.g., CSI-RS) and/or receiving related UL transmissions. As a result, the network node may create reception/transmission gaps during which it may reduce receiver-related and/or transmission-related activities (e.g., utilizing various sleep states depending on gap length) and thereby save energy. With invalidation of some activities, the network node and wireless device may also improve resource utilization by, for example, optimizing PDSCH and/or PUSCH transmission.

FIG. 3 is a flowchart illustrating a method performed by a wireless device for requesting output power adaptation of a network node according to some embodiments of the present disclosure. The wireless device may be implemented with the wireless device 100 in FIG. 1. The method may include invalidating an activity of the wireless device in response to an invalidation configuration being configured for invalidating an activity of the wireless device (step 302). In some embodiments, the method may also optionally include, as shown in dashed-line blocks in FIG. 3, one or more of: receiving a signal explicitly indicating the invalidation configuration, or receiving a defined configuration implying the invalidation configuration (step 300); resuming the activity of the wireless device in response to a cancellation configuration being configured for canceling the invalidation configuration and resuming the activity (step 304).

In some embodiments, the invalidation configuration is related to at least one of:
periodic or semi-persistent reference signals in downlink and/or uplink,
periodic or semi-persistent grant,
Physical Downlink Control Channel (PDCCH) Monitoring (MO),
search space for scheduling PDCCH,
Physical Random Access Channel (PRACH) access resources,
Physical Uplink Control Channel (PUCCH)/Physical Uplink Shared Channel (PUSCH) resources,
Synchronization Signal Block (SSB), and
System Information Block (SIB).

In some embodiments, the activity may comprise at least one of:
reception of periodic or semi-persistent reference signals in downlink and/or uplink,
   Note that, from the perspective of the wireless device, this can be restated as reception of periodic or semi-persistent downlink reference signals and/or transmission of periodic or semi-persistent uplink reference signals.
measurement of reference signals,
reception of scheduling PDCCH,
transmission of periodic or semi-persistent reference signal report,
transmission and/or reception of periodic or semi-persistent uplink grants/downlink assignments,
   Note that, from the perspective of the wireless device, this can be restated as reception of periodic or semi-persistent uplinks grants and/or downlink assignments.
transmission of a scheduling request,
transmission of a preamble on PRACH,
reception of SSB, either group or individual SSB,
reception of SIB, and
transmission/reception of PUCCH/Physical Downlink Shared Channel (PDSCH).
   Note that, from the perspective of the wireless device, this can be restated as transmission of PUCCH and/or reception of PDSCH.

In some embodiments, the invalidation configuration comprises an invalidation duration in which the wireless device refrains from performing the activity, or a reference to one or more of a set of preconfigured invalidation durations. The invalidating the activity of the wireless device comprises: refraining from performing the activity for a period according to the invalidation duration.

In some embodiments, the invalidation duration is represented by a preconfigured value in unit of time, or by a relative value which is a multiple of a specific time length, or is numerology dependent or independent.

In some embodiments, the invalidation duration is defined per activity, or per channel, or per transmission direction, or per SSB, or per signal, or per cell; and the method further comprises, before invalidating the activity of the wireless device: determining whether the invalidation duration is defined for the activity; and invalidating the activity of the wireless device comprises: if it is determined that the invalidation duration is defined for the activity, refraining from performing the activity for a period with respect to a channel, or a transmission direction, or a SSB, or a signal, or a cell according to the invalidation duration.

In some embodiments, the wireless device is informed of the set of preconfigured invalidation durations via a first signaling, and then informed of which invalidation duration from the set is to be currently applied via a second signaling.

In some embodiments, the invalidation configuration comprises an invalidation pattern or a reference to one of a set of preconfigured patterns, which indicates a pattern in which the wireless device invalidates the activity, and invalidating the activity of the wireless device comprises: refraining from performing the activity according to the invalidation pattern.

In some embodiments, the invalidation pattern indicates when the wireless device remains performing the activity, or when the wireless device refrains from performing the activity.

In some embodiments, the invalidation pattern indicates periodicity configured for the activity, and invalidating the activity of the wireless device comprises: refraining from performing the activity in a periodic manner according to the periodicity.

In some embodiments, the periodicity is configured as a predefined value in unit of time, or as an integer value which is multiplied with a specific periodicity.

In some embodiments, the periodicity configured in the invalidation pattern overwrites a periodicity originally configured for the activity.

In some embodiments, the invalidation configuration comprises a duration configured to define how long the invalidation pattern should be applied to the activity, and invalidating the activity of the wireless device comprises: refraining from performing the activity according to the invalidation pattern for the configured duration.

In some embodiments, the invalidation configuration comprises one or more formats defined through higher layer signaling.

In some embodiments, the one or more formats are defined as UE specific, group-common, or cell specific, and/or the one or more formats are defined the same or different for different activities, signals, channels, or operations; and invalidating the activity of the wireless device comprises: refraining from performing the activity according to the one or more formats.

In some embodiments, the invalidation configuration is configured for specific instances of a recurrent transmission.

In some embodiments, the invalidation configuration is in a form of ssb-PositionsInBurst, called invalidSsb-PositionsInBurst, pointing out one or more instances of the SSBs that are invalidated, or update content of SSBperiodicity or SSBtomeasure without a need for SI update or Radio Resource Control (RRC) reconfiguration.

In some embodiments, the format is a Downlink Control Information (DCI) format or a Medium Access Control Layer-Control Element (MAC-CE) format.

In some embodiments, the invalidation configuration comprises a number of bits that are used in invalidation signaling bitfield.

In some embodiments, the invalidation configuration comprises a length, a location or a size of the bitfield in a DCI format.

In some embodiments, the number of bits includes a predefined value, or based on a number of durations or patterns included in the invalidation configuration.

In some embodiments, the invalidation configuration comprises a codepoint representation including one or more codepoints for representing whether there is invalidation configuration or not, or the invalidation durations or patterns.

In some embodiments, the number of codepoints is based on a number of durations or patterns included in the invalidation configuration.

In some embodiments, the invalidation configuration comprises one or more codepoints for representing activities or instances of transmission within an activity to be invalidated.

In some embodiments, the invalidation configuration is configured and transmitted through broadcast channel or system information.

In some embodiments, the invalidation configuration comprises a timing indication indicating a timing to apply activity invalidation, and invalidating the activity of the wireless device comprises: refraining from performing the activity at the timing indicated by the timing indication.

In some embodiments, refraining from performing the activity at the timing indicated by the timing indication comprises: refraining from performing the activity directly after receiving the invalidation configuration; or refraining from performing the activity at a symbol which is at least P symbols or Q slots after the last symbol of PDCCH containing the invalidation configuration, wherein the values of P and Q are preconfigured, or based on numerology, or configured based on processing capability of the wireless device.

In some embodiments, the timing indication is configured differently per activity, per operation, per channel, per cell, per Bandwidth Part (BWP), per band.

In some embodiments, the timing indication is configured based on a specific reference time in relation to the invalidation configuration.

In some embodiments, the invalidation configuration is configured in a periodic manner, and invalidating the activity of the wireless device comprises: refraining from performing the activity periodically according to the invalidation configuration.

In some embodiments, a period of the invalidation configuration comprises an invalidation interval and a non-invalidation interval defined by one or more offsets from a beginning of a specific period.

In some embodiments, the method may further comprise resuming the activity of the wireless device in response to a cancellation configuration being configured for canceling the invalidation configuration and resuming the activity.

In some embodiments, the cancellation configuration is represented by a codepoint included in the invalidation configuration, or is configured in a same or different manner as the invalidation configuration.

In some embodiments, the method may further comprise: controlling counting operations of one or more timers included in the wireless device in response to the invalidation configuration being configured.

FIG. 4 is a flowchart illustrating a method performed by a network node according to some embodiments of the present disclosure. The network node may be implemented with the network node 200 in FIG. 2. In some embodiments, the method performed by the network node may include: informing to a wireless device an invalidation configuration for invalidating an activity of the wireless device (step 402). In some embodiments, as shown in dashed-line blocks in FIG. 4, the method may also optionally include one or more of: configuring the invalidation configuration (step 400); refraining from performing an activity of the network node corresponding to the activity of the wireless device in accordance with the invalidation configuration (step 404); informing to the wireless device a cancellation configuration for canceling the invalidation configuration and resuming the activity, and resuming the activity of the network node according to the cancellation configuration (step 406).

In some embodiments, the network node may inform the invalidation configuration by transmitting a signal explicitly indicating the invalidation configuration, or transmitting a defined configuration implying the invalidation configuration.

So far, the methods performed by wireless device and network node have been described. In the following, these methods will be further explained with reference to exemplary embodiments in which the wireless device is embodied with UE, and the network node is embodied with gNB.

It is assumed that the UE is configured by the gNB, e.g., via dedicated or broadcast RRC configurations with e.g., periodic or semi-persistent reference signal in either uplink such as sounding reference signal (SRS) or downlinks such as CSI-RS or SSB, periodic or semi-persistent reporting such as CSI report, and periodic or semi-persistent UL grant or DL assignments for data transmission or reception respectively, or PRACH occasion(s) used for random access. The UE may also be configured to monitor for DL data transmissions via PDCCH reception in the configured search space. The UE may also have received an aperiodic UL grant such as PUCCH or PUSCH,

Further, configuration of the reference signal and PRACH may include one or more of resource mapping, power control, scrambling ID, periodicity and offset, etc. The configuration of the CSI report config may include the report config ID, the report config type, the periodicity and offset, etc.

Alternatively, configuration for activity invalidation may specify that irrespective of the type of activity (UL/DL grants/assignments/PRACH occasions/Reference signals/Scheduling requests, etc.), the activities are invalidated for a duration of time and/or according to a certain period in one or more directions (i.e., UL and/or DL). In yet another alternative, the invalidation may be specified per channel, for example, the gNB may invalidate any activity on a PUCCH channel or generally UL channel, but not on the DL channel or vice versa.

Configuration for activity invalidation may be indicated in an explicit manner, such as by defining an invalidation signal, or indicated in an implicit way. Herein, an invalidation signal may refer to a signal received by the UE, which is transmitted by the gNB, which informs the UE that at least part of its activities (e.g., transmission, reception, measurement, monitoring activities) may be refrained, for example, for at least a certain duration. As an example, the invalidation signal may inform only applying to CSI-RS measurement and/or reporting, but not to PUSCH scheduled by a periodic or aperiodic grant. In another example, invalidation may be applied to any activity in a certain direction, i.e., either DL or UL or both. The invalidation signal may further address specific instances of a recurrent transmission. For example, the invalidation signal may be in the form of ssb-PositionsInBurst (e.g., called invalidSsb-PositionsInBurst) pointing out one or more instances of the SSBs that are invalidated, or update the content of SSBperiodicity or SSBtomeasure without needing for SI update or RRC reconfiguration.

For the case that configuration for activity invalidation is implicitly indicated, in an example, the UE may receive a Bandwidth Part (BWP) configuration with less periodic or semi-persistent configuration than other BWPs, or no specific configured activities, or different TDD patterns, and so on. The UE may then receive a group-common or cell level DCI indicating such change in the BWP, and as such one or more activities (and associated signals) may be implicitly invalidated by the change in the BWP. In another example, the UE can be configured with a group common or cell/area specific BWP change, e.g., within the existing DCIs (e.g., scrambled with a Group RNTI (G-RNTI)), or one or more DCI formats defined for indicating such change.

### Configuration for Activity Invalidation

In one embodiment, configuration for activity invalidation (hereafter referred to as “invalidation configuration”) may include at least a duration or a reference to one of a set of preconfigured durations, which determines a length of a period in which activities (e.g., transmission and/or reception) may be deemed as invalid. For example, being invalid may refer to, e.g., CSI-RSs are not transmitted by the gNB, and thus the UE may not need to do CSI-RS measurements. The duration may be an exact value, e.g., in slot, milliseconds, etc. In another example, the duration may be a relative value, e.g., in multiple of Discontinuous Reception (DRX) cycle length, subframes, etc. In one embodiment, there may be multiple invalidation configurations specified for different activities. For example, the activities may include reception of periodic or semi-persistent CSI-RS, reception of scheduling PDCCH, transmission of periodic or semi-persistent CSI-RS report, transmission and/or reception of periodic or semi-persistent UL grants/DL assignments, transmission of a scheduling request, transmission of a preamble on PRACH, reception of SSB, either group or individual SSBs, reception of a system information block (SIB), transmission or reception of PUCCH/PDSCH, and the like. For example, the duration length and/or pattern of invalidation configuration may be different for CSI-RS transmission by the gNB compared to SRS transmission by the UE.

In one embodiment, multiple invalidation durations of time are preconfigured in standard specifications or configured via a first signaling, and then a second signaling is used to notify the UE which specific invalidation duration applies for this time instance. The first signaling may be RRC, broadcast signaling, e.g., SIB, etc. The second signaling may be, for example, broadcast signaling, e.g., G-RNTI based MAC-CE, or DCI. The duration of invalidation period may be either numerology dependent or independent.

In one embodiment, the invalidation duration may be channel dependent, e.g., UL or DL, or channels related to specific tasks which are being invalidated. In an example, the invalidation configuration may indicate to invalidate a first signal with a first duration and a second signal with a second duration. In another example, the UE may receive an invalidation signal, indicating to skip monitoring PDCCH for 10 ms and refrain from transmitting on the UL channel for 8 ms.

In one embodiment, the invalidation duration may not be configured, but a default value is considered as a pre-configured value. The default value may certain value documented in standard specifications, for example.

In an alternative embodiment, the invalidation configuration may include at least a pattern or a reference to one of a set of preconfigured patterns in which the UE needs to do (or is allowed to do) some of its activities. The pattern may indicate either when the activities remain valid or when the activities may be refrained. In one example, the invalidation configuration may include periodicity. Here, e.g., the periodicity may overwrite periodicity configured for some periodic or semi-persistent activities. In one example, the UE may be configured with a periodic CSI-RS with a periodicity of X ms or slots, and the invalidation configuration is configured with Y ms of periodicity. If an invalidation signal carrying the invalidation configuration is not received by the UE, the UE may measure CSI-RS and transmit reports with a periodicity of X ms or slots. If the invalidation signal is received by the UE, the UE may then measure CSI-RS with a periodicity of Y ms or slots. The periodicity may be represented by a value which may be configured as actual values of the periodicity, such as Y ms, or may be configured as an integer value, e.g., Z. In the latter case, the UE may then apply Z.X ms as the periodicity for CSI-RS measurement. Further, a total duration may also be configured to determine how long the invalidation pattern will be applied.

In another embodiment, the invalidation configuration may be received by the UE e.g., through higher layer signaling such as Radio Resource Control (RRC) signaling or SIB, which defines one or more formats related to the invalidation configuration. The invalidation configuration may also indicate whether each format is applicable to all types of the underlying signals or a subset of them. For example, a first format may indicate that the UE should skip transmitting PUCCH, PUSCH, or PRACH during the invalidation duration, while a second format may indicate that the UE should skip monitoring PDCCH, or change Synchronization Signal (SS), e.g., to a sparser SS configuration. In another example, the same or different formats may be used to invalidate different types of activities, including signals, channels, or configured operations, e.g., periodic CSI-RS/SSB measurements, and request for on-demand SIB. Each format may be any of Downlink Control Information (DCI) or Medium Access Control Layer-Control Element (MAC-CE), and furthermore, may be UE specific, group-common, or cell specific. The invalidation configuration may be configured to be applicable to only the current cell or also additional cells, e.g., one or more of Secondary Cells (SCells). In an example, the UE may receive invalidation configuration on Primary Cell (PCell) indicating that one or more of SSBs are not going to be transmitted on one or more of SCells for a specific duration of time. Such indication may for example be done through, for example, invalidSsb-PositionsInBurst parameter exemplified above.

### Bitfield for Invalidation Configuration

In one embodiment, the invalidation configuration may include the number of bits that will be used in an invalidation signaling bitfield, e.g., if the invalidation signal is in a format of DCI. The configuration may also include a length and a location of the bitfield in the DCI format. If it is an independent DCI, e.g., a newly defined DCI format, the DCI size may also be configured. In one example, the number of bits may be an exact value, e.g., 1, 2, 3 bits, etc. The exact value may be a predetermined value, e.g., in standard specifications, or may be explicitly configured for the UE, e.g., in RRC configurations. In another example, the number of bits may be based on the number of durations or patterns included in the invalidation configuration configured for the UE.

In some embodiments, a codepoint representation may be used to indicate activity invalidation. Here, one codepoint may be assigned to indicate no invalidation, e.g., indicate the UE to continue or resume its “normal” transmission/reception activities. In an example, the bit value of (00, 01, 10, 11) may represent “no invalidation”, “first configured duration of invalidation,” “second configured duration of invalidation,” and “third configured duration of invalidation,” respectively. The number of bits in the invalidation signaling bitfield may be equal to ┌log₂ N+1┐ bits, where N is the number of durations or patterns of the invalidation configuration configured for the UE. Alternatively, the number of bits may be equal to ┌log₂ N┐. This option may be used if “no invalidation” is explicitly configured, e.g., by setting the invalidation duration to 0.

In some embodiments, the codepoint approach may be used to indicate activities that should be invalidated, according to a predefined (configured or specified) list of options. A larger code point space may be created by combining duration, pattern, application delay (to be described later), activity type, and/or additional signaling dimensions. Similarly, code points may be used to indicate invalidating specific instances of transmissions within an activity, such as specific instances of one or more SSBs (e.g., SSBs 1, 2, 3, 4) from a total set of SSBs (e.g., from a total of 8 SSBs).

In one embodiment, the invalidation configuration, e.g., an invalidation signal, may be transmitted in at least one DCI format. For example, the invalidation configuration may be signaled via non-scheduling DCI format, e.g., DCI format 2-0, a newly defined DCI format, etc. In another example, the invalidation configuration may also be signaled via a scheduling DCI, e.g., DCI 1-0/1-1/1-2/0-0/0-1/0-2. In addition, the signaling may be scrambled by a currently existing Radio Network Temporary Identity (RNTI) or by a newly defined RNTI. The RNTI may be applicable to a specific UE, a group of UEs, or all UEs in a cell or a geographical or tracking area. In one embodiment, the invalidation configuration may be informed to the UE through a broadcast channel or system information, e.g., a DCI scrambled with System Information RNTI (SI-RNTI) associated with a SIB transmission.

As mentioned earlier, multiple DCIs or Medium Access Control (MAC) Control Elements (CEs) may be defined to be applicable to one or more of transmission or reception signals/channels to be deactivated. For example, DCI formats 0-1/0-2/1-1 and 1-2 may be used currently to indicate a PDCCH skipping signal or a SS switch. Such DCIs are typically scrambled with UE-specific RNTIs such as C-RNTI and transmitted over USS (UE specific search space). In an alternative embodiment, the DCIs may be allowed to be scrambled with group-common or cell or area specific RNTIs and transmitted over a Common Search Space (CSS) in order to indicate PDCCH skip or search space switch to a group of UEs or all the UEs within the cell. The same DCIs or newly defined ones may additionally be configured to indicate skipping one or more of UL channels, e.g., PUCCH/PUSCH or PRACH or SRS transmissions.

### Application Delay

In one embodiment, at least one of activities of UE may be refrained directly after the UE receives the invalidation configuration/signal. For example, at least one of transmission/reception activities may be refrained from the start of the last symbol of PDCCH containing the invalidation configuration/signal.

In another embodiment, application delay may apply. In one example, invalidation of at least one of transmission/reception activities may start at a first symbol of the first slot after the last PDCCH containing the invalidation configuration/signal. In another example, the application delay may be determined in a symbol or slot manner. For example, the UE may start to refrain from its transmission/reception activities at a symbol which is at least P symbols or Q slots after the last symbol of the PDCCH containing the invalidation configuration/signal. In a further example, the application delay may also be rounded to the first symbol of a slot. E.g., the UE may start to refrain from the transmission/reception activities by starting at a first symbol of the first slot which is at least P symbols or Q slots after the last symbol of the PDCCH containing the invalidation configuration/signal.

The value of P or Q may be predetermined (e.g., in standard specifications), or may be based on numerology (sub-carrier spacing) and/or UE processing capability. Alternatively, the value of P or Q may be configured by the gNB. Here, a restriction on possible configured values may be adopted. For example, the UE cannot be configured with the P or Q value that is less than a certain minimum value. The minimum value may be further based on the numerology and/or the UE processing capability.

In another embodiment, the application delay may also be operation dependent, e.g., after the current Hybrid Automatic Repeat Request (HARQ) process, or after the current CSI report, and so on. The application delay may also be channel dependent, e.g., UL and/or DL dependent, or depend on a specific control or data channels, or it may depend on the numerology. If configured from higher layers, application delay may also be applicable to UEs, specific bands, specific cells, or specific BWPs.

In yet another embodiment, activity invalidation may be applied by the UE according to a specific reference time in relation to the invalidation configuration/signal, such as the nearest even frame number after the PDCCH containing the invalidation configuration/signal, or after certain application delay after the reception of PDCCH containing the invalidation configuration/signal.

### Cancellation of Activity Invalidation

In some embodiments, activity invalidation may be cancelled, that is, the UE may resume (i.e., the gNB may re-validate) the “normal” aperiodic, periodic, or semi-persistent activities, for example, when the duration of the invalidation signal ends. In one embodiment, the UE may also be indicated with an explicit cancellation signal which indicates that the invalidated activities should be resumed. In one example, the cancellation indication may be a certain codepoint in the invalidation signal bitfield, e.g., a codepoint of 00 as described in the above embodiment. The UE may resume its activities once it receives the explicit cancellation signal, or after a predetermined or configured application delay by any of the methods mentioned in the above part. Alternatively, the re-validation of activities may be indicated implicitly. For example, a DCI format may be used for invalidation to invalidate certain activities, but another DCI format, or a DCI with specific contents (e.g., BWP switch) may be used to implicitly indicate re-validation of the activities.

The UE may optionally receive a dedicated, cell-common, or group-common cancellation signal of the invalidation and resume the normal operation.

The cancellation signal may be received as part of an existing DCI or MAC-CE message or maybe a newly introduced DCI or MAC-CE message for the purpose of invalidation. The cancellation signal may carry the cancellation period/pattern information.

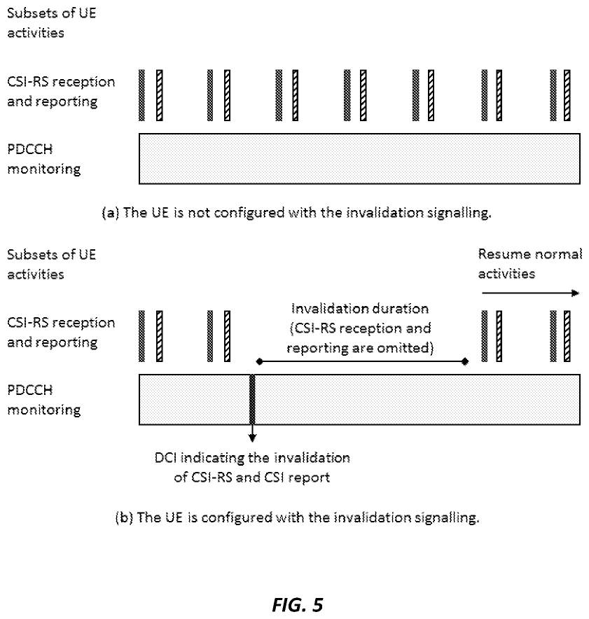

FIG. 5 shows an example of an invalidation signaling via DCI for periodic CSI-RS and CSI report transmission/reception. In the upper part (a), it is shown that the UE is not configured with the invalidation signaling. The UE performs PDCCH monitoring and periodic CSI-RS and CSI report transmission/reception as normal. The lower part (b) shows that the UE is configured with the invalidation signaling. DCI is used for indicating the invalidation of CSI-RS and CSI report, and the UE does not perform CSI-RS and CSI report transmission/reception during the invalidation duration. After the invalidation duration ends, the UE may resume normal activities.

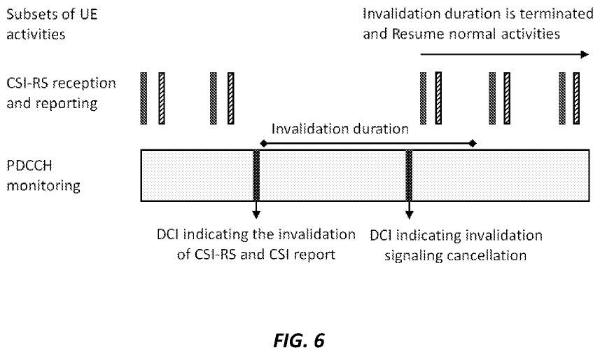

FIG. 6 shows an example of invalidation signaling with invalidation signaling cancelation via DCI. Different from FIG. 5, DCI is used for indicating cancellation of the invalidation signaling. The UE may know that the invalidation duration is terminated and resume normal activities when it received the signaling for cancellation of the invalidation signaling.

### Periodic Invalidation

In some embodiments, the UE may receive an invalidation configuration that applies periodically, e.g., during a certain fraction of each frame or each SSB period. This may allow the gNB, e.g., during temporary low load intervals, to reduce both UE and gNB activities without requiring RRC reconfiguration of all connected UEs or system information update for all idle mode UEs.

In some embodiments, when the period of applying an invalidation configuration equals the SSB period, the valid and invalid parts of the invalidation period may be defined by specifying a first offset from the beginning of the SSB period as the beginning of an invalidation interval, and a second offset from the beginning of the SSB period as the end of the invalidation interval. The UE then operates as usual during non-invalidated intervals but refrains from specified activities during invalidation intervals, where the specified activities may be described as above, e.g., all or specific instances of one or more SSBs are invalidated.

In such embodiments where invalidation configuration that applies periodically, since activity invalidation may be a longer-term configuration, it is configured using MAC-CE or RRC signaling to obtain wider configuration flexibility, and ensure robustness in terms of UE/NW alignment. A command from the NW (e.g., gNB) may include one or more of the following parameters:
the first and second offsets (e.g., in symbols or ms) as described above,
procedures to refrain from or omit activities as described above,
duration of invalidation (e.g., in ms, frames, . . . ), or indefinite until explicit cancellation received.

In a variant of the above embodiment, the periodic invalidation configuration may be provided via MAC-CE or RRC signaling, but it may be activated and/or canceled via DCI signaling. The invalidation configuration may be provided via dedicated signaling while activation/deactivation of the invalidation configuration may use, e.g., group-common signaling.

In one embodiment, an ongoing periodic invalidation may be canceled using a cancellation signal transmitted using the same mechanism as the invalidation activation signal.

### Impact on Timer

When invalidation configuration is provided or signaled, impact on the timers maintained at the UE side may also be considered. The timers may include a Discontinuous Reception (DRX) timer, Radio Link Failure (RLF) timer, Beam failure timer, etc. In one embodiment, the timers may remain to count despite the UE being indicated with invalidation configuration. In another embodiment, the timers may not count down during a period for applying activity invalidation, i.e., the timers may be frozen. In yet another embodiment, different handling for different timers may apply. For example, the timers related to the MAC entity may remain to count while the timers related to layer 1 (L1) activities, such as the PDCCH-skipping timer, may not count.

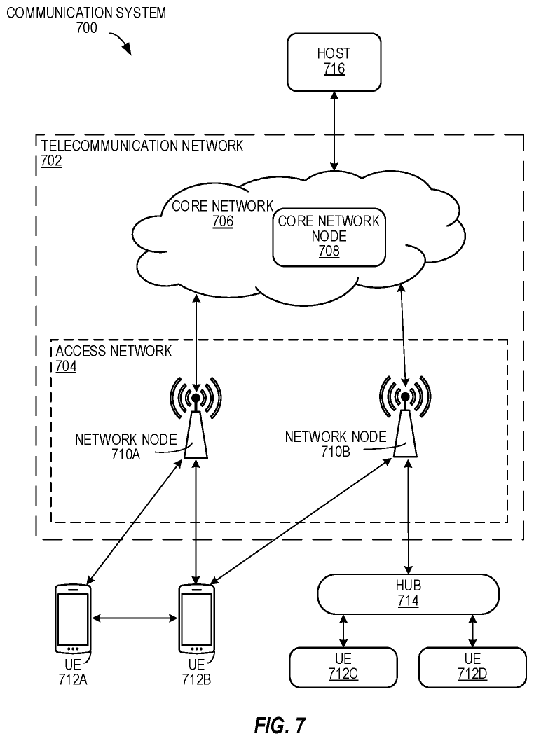

FIG. 7 shows an example of a communication system 700 in accordance with some embodiments.

In the example, the communication system 700 includes a telecommunication network 702 that includes an access network 704, such as a radio access network (RAN), and a core network 706, which includes one or more core network nodes 708. The access network 704 includes one or more access network nodes, such as network nodes 710a and 710b (one or more of which may be generally referred to as network nodes 710), or any other similar 3rd Generation Partnership Project (3GPP) access nodes or non-3GPP access points. Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network 702 includes one or more Open-RAN (ORAN) network nodes. An ORAN network node is a node in the telecommunication network 702 that supports an ORAN specification (e.g., a specification published by the O-RAN Alliance, or any similar organization) and may operate alone or together with other nodes to implement one or more functionalities of any node in the telecommunication network 702, including one or more network nodes 710 and/or core network nodes 708.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes 710 facilitate direct or indirect connection of user equipment (UE), such as by connecting UEs 712a, 712b, 712c, and 712d (one or more of which may be generally referred to as UEs 712) to the core network 706 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 700 may include any number of wired or wireless networks, network nodes, UEs, and/or any other components or systems that may facilitate or participate in the communication of data and/or signals whether via wired or wireless connections. The communication system 700 may include and/or interface with any type of communication, telecommunication, data, cellular, radio network, and/or other similar type of system.

The UEs 712 may be any of a wide variety of communication devices, including wireless devices arranged, configured, and/or operable to communicate wirelessly with the network nodes 710 and other communication devices. Similarly, the network nodes 710 are arranged, capable, configured, and/or operable to communicate directly or indirectly with the UEs 712 and/or with other network nodes or equipment in the telecommunication network 702 to enable and/or provide network access, such as wireless network access, and/or to perform other functions, such as administration in the telecommunication network 702.

In the depicted example, the core network 706 connects the network nodes 710 to one or more hosts, such as host 716. These connections may be direct or indirect via one or more intermediary networks or devices. In other examples, network nodes may be directly coupled to hosts. The core network 706 includes one more core network nodes (e.g., core network node 708) that are structured with hardware and software components. Features of these components may be substantially similar to those described with respect to the UEs, network nodes, and/or hosts, such that the descriptions thereof are generally applicable to the corresponding components of the core network node 708. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 716 may be under the ownership or control of a service provider other than an operator or provider of the access network 704 and/or the telecommunication network 702, and may be operated by the service provider or on behalf of the service provider. The host 716 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 700 of FIG. 7 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 702 is a cellular network that implements 3GPP standardized features. Accordingly, the telecommunications network 702 may support network slicing to provide different logical networks to different devices that are connected to the telecommunication network 702. For example, the telecommunications network 702 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 712 are configured to transmit and/or receive information without direct human interaction. For instance, a UE may be designed to transmit information to the access network 704 on a predetermined schedule, when triggered by an internal or external event, or in response to requests from the access network 704. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 714 communicates with the access network 704 to facilitate indirect communication between one or more UEs (e.g., UE 712c and/or 712d) and network nodes (e.g., network node 710b). In some examples, the hub 714 may be a controller, router, content source and analytics, or any of the other communication devices described herein regarding UEs. For example, the hub 714 may be a broadband router enabling access to the core network 706 for the UEs. As another example, the hub 714 may be a controller that sends commands or instructions to one or more actuators in the UEs. Commands or instructions may be received from the UEs, network nodes 710, or by executable code, script, process, or other instructions in the hub 714. As another example, the hub 714 may be a data collector that acts as temporary storage for UE data and, in some embodiments, may perform analysis or other processing of the data. As another example, the hub 714 may be a content source. For example, for a UE that is a VR headset, display, loudspeaker or other media delivery device, the hub 714 may retrieve VR assets, video, audio, or other media or data related to sensory information via a network node, which the hub 714 then provides to the UE either directly, after performing local processing, and/or after adding additional local content. In still another example, the hub 714 acts as a proxy server or orchestrator for the UEs, in particular if one or more of the UEs are low energy IoT devices.

The hub 714 may have a constant/persistent or intermittent connection to the network node 710b. The hub 714 may also allow for a different communication scheme and/or schedule between the hub 714 and UEs (e.g., UE 712c and/or 712d), and between the hub 714 and the core network 706. In other examples, the hub 714 is connected to the core network 706 and/or one or more UEs via a wired connection. Moreover, the hub 714 may be configured to connect to an M2M service provider over the access network 704 and/or to another UE over a direct connection. In some scenarios, UEs may establish a wireless connection with the network nodes 710 while still connected via the hub 714 via a wired or wireless connection. In some embodiments, the hub 714 may be a dedicated hub—that is, a hub whose primary function is to route communications to/from the UEs from/to the network node 710b. In other embodiments, the hub 714 may be a non-dedicated hub—that is, a device which is capable of operating to route communications between the UEs and network node 710b, but which is additionally capable of operating as a communication start and/or end point for certain data channels.

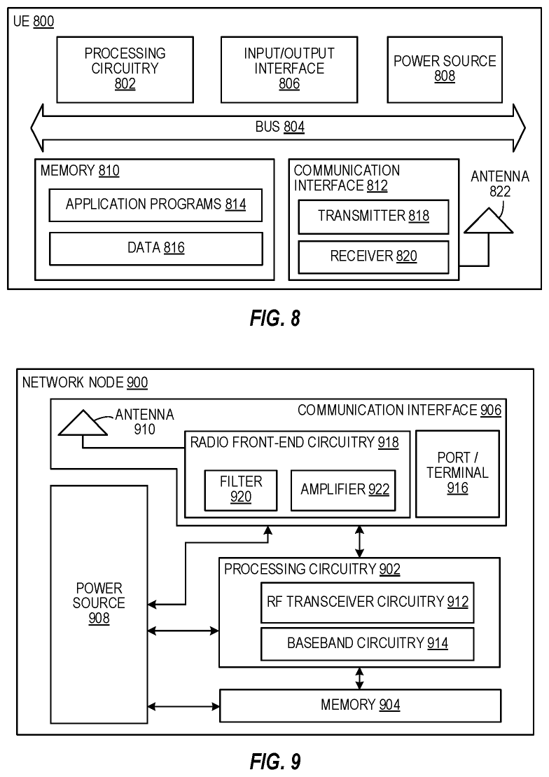

FIG. 8 shows a UE 800 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle, vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 800 includes processing circuitry 802 that is operatively coupled via a bus 804 to an input/output interface 806, a power source 808, a memory 810, a communication interface 812, and/or any other component, or any combination thereof. Certain UEs may utilize all or a subset of the components shown in FIG. 8. The level of integration between the components may vary from one UE to another UE. Further, certain UEs may contain multiple instances of a component, such as multiple processors, memories, transceivers, transmitters, receivers, etc.

The processing circuitry 802 is configured to process instructions and data and may be configured to implement any sequential state machine operative to execute instructions stored as machine-readable computer programs in the memory 810. The processing circuitry 802 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 802 may include multiple central processing units (CPUs).

In the example, the input/output interface 806 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 800. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 808 is structured as a battery or battery pack. Other types of power sources, such as an external power source (e.g., an electricity outlet), photovoltaic device, or power cell, may be used. The power source 808 may further include power circuitry for delivering power from the power source 808 itself, and/or an external power source, to the various parts of the UE 800 via input circuitry or an interface such as an electrical power cable. Delivering power may be, for example, for charging of the power source 808. Power circuitry may perform any formatting, converting, or other modification to the power from the power source 808 to make the power suitable for the respective components of the UE 800 to which power is supplied.

The memory 810 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 810 includes one or more application programs 814, such as an operating system, web browser application, a widget, gadget engine, or other application, and corresponding data 816. The memory 810 may store, for use by the UE 800, any of a variety of various operating systems or combinations of operating systems.

The memory 810 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 810 may allow the UE 800 to access instructions, application programs and the like, stored on transitory or non-transitory memory media, to off-load data, or to upload data. An article of manufacture, such as one utilizing a communication system may be tangibly embodied as or in the memory 810, which may be or comprise a device-readable storage medium.

The processing circuitry 802 may be configured to communicate with an access network or other network using the communication interface 812. The communication interface 812 may comprise one or more communication subsystems and may include or be communicatively coupled to an antenna 822. The communication interface 812 may include one or more transceivers used to communicate, such as by communicating with one or more remote transceivers of another device capable of wireless communication (e.g., another UE or a network node in an access network). Each transceiver may include a transmitter 818 and/or a receiver 820 appropriate to provide network communications (e.g., optical, electrical, frequency allocations, and so forth). Moreover, the transmitter 818 and receiver 820 may be coupled to one or more antennas (e.g., antenna 822) and may share circuit components, software or firmware, or alternatively be implemented separately.

In the illustrated embodiment, communication functions of the communication interface 812 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 812, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 800 shown in FIG. 8.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 9 shows a network node 900 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)), O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 900 includes a processing circuitry 902, a memory 904, a communication interface 906, and a power source 908. The network node 900 may be composed of multiple physically separate components (e.g., a NodeB component and a RNC component, or a BTS component and a BSC component, etc.), which may each have their own respective components. In certain scenarios in which the network node 900 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 900 may be configured to support multiple radio access technologies (RATs). In such embodiments, some components may be duplicated (e.g., separate memory 904 for different RATs) and some components may be reused (e.g., a same antenna 910 may be shared by different RATs). The network node 900 may also include multiple sets of the various illustrated components for different wireless technologies integrated into network node 900, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 900.

The processing circuitry 902 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 900 components, such as the memory 904, to provide network node 900 functionality.

In some embodiments, the processing circuitry 902 includes a system on a chip (SOC). In some embodiments, the processing circuitry 902 includes one or more of radio frequency (RF) transceiver circuitry 912 and baseband processing circuitry 914. In some embodiments, the radio frequency (RF) transceiver circuitry 912 and the baseband processing circuitry 914 may be on separate chips (or sets of chips), boards, or units, such as radio units and digital units. In alternative embodiments, part or all of RF transceiver circuitry 912 and baseband processing circuitry 914 may be on the same chip or set of chips, boards, or units.

The memory 904 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 902. The memory 904 may store any suitable instructions, data, or information, including a computer program, software, an application including one or more of logic, rules, code, tables, and/or other instructions capable of being executed by the processing circuitry 902 and utilized by the network node 900. The memory 904 may be used to store any calculations made by the processing circuitry 902 and/or any data received via the communication interface 906. In some embodiments, the processing circuitry 902 and memory 904 is integrated.

The communication interface 906 is used in wired or wireless communication of signaling and/or data between a network node, access network, and/or UE. As illustrated, the communication interface 906 comprises port(s)/terminal(s) 916 to send and receive data, for example to and from a network over a wired connection. The communication interface 906 also includes radio front-end circuitry 918 that may be coupled to, or in certain embodiments a part of, the antenna 910. Radio front-end circuitry 918 comprises filters 920 and amplifiers 922. The radio front-end circuitry 918 may be connected to an antenna 910 and processing circuitry 902. The radio front-end circuitry may be configured to condition signals communicated between antenna 910 and processing circuitry 902. The radio front-end circuitry 918 may receive digital data that is to be sent out to other network nodes or UEs via a wireless connection. The radio front-end circuitry 918 may convert the digital data into a radio signal having the appropriate channel and bandwidth parameters using a combination of filters 920 and/or amplifiers 922. The radio signal may then be transmitted via the antenna 910. Similarly, when receiving data, the antenna 910 may collect radio signals which are then converted into digital data by the radio front-end circuitry 918. The digital data may be passed to the processing circuitry 902. In other embodiments, the communication interface may comprise different components and/or different combinations of components.

In certain alternative embodiments, the network node 900 does not include separate radio front-end circuitry 918, instead, the processing circuitry 902 includes radio front-end circuitry and is connected to the antenna 910. Similarly, in some embodiments, all or some of the RF transceiver circuitry 912 is part of the communication interface 906. In still other embodiments, the communication interface 906 includes one or more ports or terminals 916, the radio front-end circuitry 918, and the RF transceiver circuitry 912, as part of a radio unit (not shown), and the communication interface 906 communicates with the baseband processing circuitry 914, which is part of a digital unit (not shown).

The antenna 910 may include one or more antennas, or antenna arrays, configured to send and/or receive wireless signals. The antenna 910 may be coupled to the radio front-end circuitry 918 and may be any type of antenna capable of transmitting and receiving data and/or signals wirelessly. In certain embodiments, the antenna 910 is separate from the network node 900 and connectable to the network node 900 through an interface or port.

The antenna 910, communication interface 906, and/or the processing circuitry 902 may be configured to perform any receiving operations and/or certain obtaining operations described herein as being performed by the network node. Any information, data and/or signals may be received from a UE, another network node and/or any other network equipment. Similarly, the antenna 910, the communication interface 906, and/or the processing circuitry 902 may be configured to perform any transmitting operations described herein as being performed by the network node. Any information, data and/or signals may be transmitted to a UE, another network node and/or any other network equipment.

The power source 908 provides power to the various components of network node 900 in a form suitable for the respective components (e.g., at a voltage and current level needed for each respective component). The power source 908 may further comprise, or be coupled to, power management circuitry to supply the components of the network node 900 with power for performing the functionality described herein. For example, the network node 900 may be connectable to an external power source (e.g., the power grid, an electricity outlet) via an input circuitry or interface such as an electrical cable, whereby the external power source supplies power to power circuitry of the power source 908. As a further example, the power source 908 may comprise a source of power in the form of a battery or battery pack which is connected to, or integrated in, power circuitry. The battery may provide backup power should the external power source fail.

Embodiments of the network node 900 may include additional components beyond those shown in FIG. 9 for providing certain aspects of the network node's functionality, including any of the functionality described herein and/or any functionality necessary to support the subject matter described herein. For example, the network node 900 may include user interface equipment to allow input of information into the network node 900 and to allow output of information from the network node 900. This may allow a user to perform diagnostic, maintenance, repair, and other administrative functions for the network node 900.

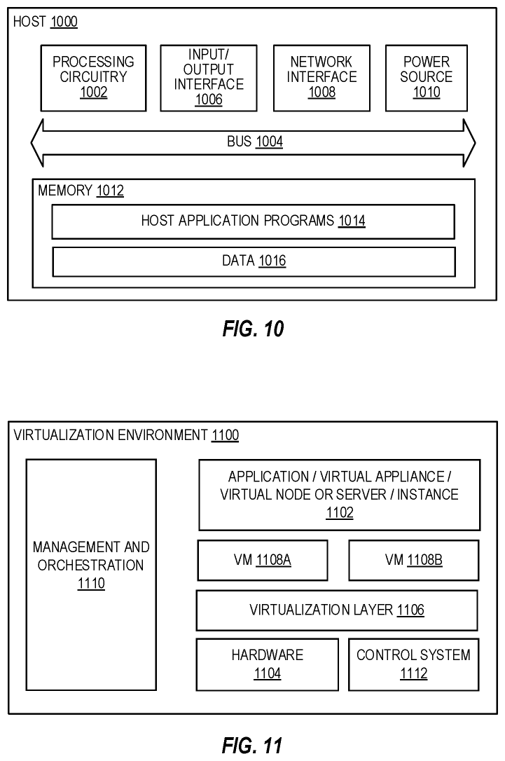

FIG. 10 is a block diagram of a host 1000, which may be an embodiment of the host 716 of FIG. 7, in accordance with various aspects described herein. As used herein, the host 1000 may be or comprise various combinations hardware and/or software, including a standalone server, a blade server, a cloud-implemented server, a distributed server, a virtual machine, container, or processing resources in a server farm. The host 1000 may provide one or more services to one or more UEs.

The host 1000 includes processing circuitry 1002 that is operatively coupled via a bus 1004 to an input/output interface 1006, a network interface 1008, a power source 1010, and a memory 1012. Other components may be included in other embodiments. Features of these components may be substantially similar to those described with respect to the devices of previous figures, such as FIGS. 8 and 9, such that the descriptions thereof are generally applicable to the corresponding components of host 1000.

The memory 1012 may include one or more computer programs including one or more host application programs 1014 and data 1016, which may include user data, e.g., data generated by a UE for the host 1000 or data generated by the host 1000 for a UE. Embodiments of the host 1000 may utilize only a subset or all of the components shown. The host application programs 1014 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1014 may also provide for user authentication and licensing checks and may periodically report health, routes, and content availability to a central node, such as a device in or on the edge of a core network. Accordingly, the host 1000 may select and/or indicate a different host for over-the-top services for a UE. The host application programs 1014 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 11 is a block diagram illustrating a virtualization environment 1100 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1100 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 1100 includes components defined by the O-RAN Alliance, such as an O-Cloud environment orchestrated by a Service Management and Orchestration Framework via an O-2 interface.

Applications 1102 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1104 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1106 (also referred to as hypervisors or virtual machine monitors (VMMs)), provide VMs 1108a and 1108b (one or more of which may be generally referred to as VMs 1108), and/or perform any of the functions, features and/or benefits described in relation with some embodiments described herein. The virtualization layer 1106 may present a virtual operating platform that appears like networking hardware to the VMs 1108.

The VMs 1108 comprise virtual processing, virtual memory, virtual networking or interface and virtual storage, and may be run by a corresponding virtualization layer 1106. Different embodiments of the instance of a virtual appliance 1102 may be implemented on one or more of VMs 1108, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1108 may be a software implementation of a physical machine that runs programs as if they were executing on a physical, non-virtualized machine. Each of the VMs 1108, and that part of hardware 1104 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1108 on top of the hardware 1104 and corresponds to the application 1102.

Hardware 1104 may be implemented in a standalone network node with generic or specific components. Hardware 1104 may implement some functions via virtualization. Alternatively, hardware 1104 may be part of a larger cluster of hardware (e.g., such as in a data center or CPE) where many hardware nodes work together and are managed via management and orchestration 1110, which, among others, oversees lifecycle management of applications 1102. In some embodiments, hardware 1104 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1112 which may alternatively be used for communication between hardware nodes and radio units.

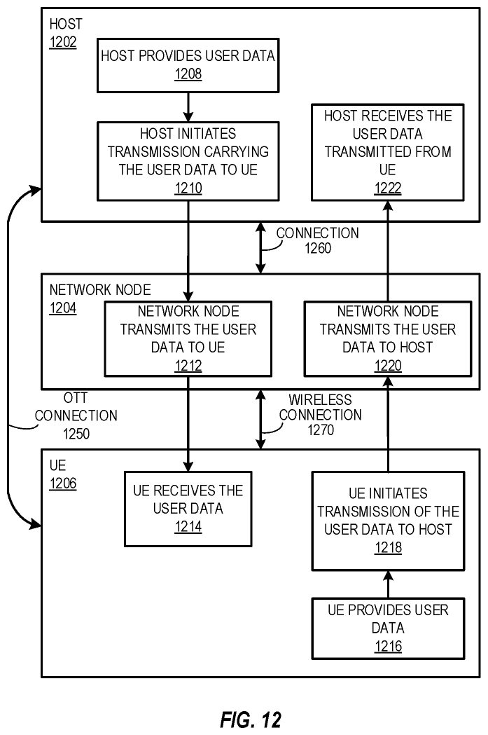

FIG. 12 shows a communication diagram of a host 1202 communicating via a network node 1204 with a UE 1206 over a partially wireless connection in accordance with some embodiments. Example implementations, in accordance with various embodiments, of the UE (such as a UE 712a of FIG. 7 and/or UE 800 of FIG. 8), network node (such as network node 710a of FIG. 7 and/or network node 900 of FIG. 9), and host (such as host 716 of FIG. 7 and/or host 1000 of FIG. 10) discussed in the preceding paragraphs will now be described with reference to FIG. 12.

Like host 1000, embodiments of host 1202 include hardware, such as a communication interface, processing circuitry, and memory. The host 1202 also includes software, which is stored in or accessible by the host 1202 and executable by the processing circuitry. The software includes a host application that may be operable to provide a service to a remote user, such as the UE 1206 connecting via an over-the-top (OTT) connection 1250 extending between the UE 1206 and host 1202. In providing the service to the remote user, a host application may provide user data which is transmitted using the OTT connection 1250.

The network node 1204 includes hardware enabling it to communicate with the host 1202 and UE 1206. The connection 1260 may be direct or pass through a core network (like core network 706 of FIG. 7) and/or one or more other intermediate networks, such as one or more public, private, or hosted networks. For example, an intermediate network may be a backbone network or the Internet.

The UE 1206 includes hardware and software, which is stored in or accessible by UE 1206 and executable by the UE's processing circuitry. The software includes a client application, such as a web browser or operator-specific “app” that may be operable to provide a service to a human or non-human user via UE 1206 with the support of the host 1202. In the host 1202, an executing host application may communicate with the executing client application via the OTT connection 1250 terminating at the UE 1206 and host 1202. In providing the service to the user, the UE's client application may receive request data from the host's host application and provide user data in response to the request data. The OTT connection 1250 may transfer both the request data and the user data. The UE's client application may interact with the user to generate the user data that it provides to the host application through the OTT connection 1250.

The OTT connection 1250 may extend via a connection 1260 between the host 1202 and the network node 1204 and via a wireless connection 1270 between the network node 1204 and the UE 1206 to provide the connection between the host 1202 and the UE 1206. The connection 1260 and wireless connection 1270, over which the OTT connection 1250 may be provided, have been drawn abstractly to illustrate the communication between the host 1202 and the UE 1206 via the network node 1204, without explicit reference to any intermediary devices and the precise routing of messages via these devices.

As an example of transmitting data via the OTT connection 1250, in step 1208, the host 1202 provides user data, which may be performed by executing a host application. In some embodiments, the user data is associated with a particular human user interacting with the UE 1206. In other embodiments, the user data is associated with a UE 1206 that shares data with the host 1202 without explicit human interaction. In step 1210, the host 1202 initiates a transmission carrying the user data towards the UE 1206. The host 1202 may initiate the transmission responsive to a request transmitted by the UE 1206. The request may be caused by human interaction with the UE 1206 or by operation of the client application executing on the UE 1206. The transmission may pass via the network node 1204, in accordance with the teachings of the embodiments described throughout this disclosure. Accordingly, in step 1212, the network node 1204 transmits to the UE 1206 the user data that was carried in the transmission that the host 1202 initiated, in accordance with the teachings of the embodiments described throughout this disclosure. In step 1214, the UE 1206 receives the user data carried in the transmission, which may be performed by a client application executed on the UE 1206 associated with the host application executed by the host 1202.

In some examples, the UE 1206 executes a client application which provides user data to the host 1202. The user data may be provided in reaction or response to the data received from the host 1202. Accordingly, in step 1216, the UE 1206 may provide user data, which may be performed by executing the client application. In providing the user data, the client application may further consider user input received from the user via an input/output interface of the UE 1206. Regardless of the specific manner in which the user data was provided, the UE 1206 initiates, in step 1218, transmission of the user data towards the host 1202 via the network node 1204. In step 1220, in accordance with the teachings of the embodiments described throughout this disclosure, the network node 1204 receives user data from the UE 1206 and initiates transmission of the received user data towards the host 1202. In step 1222, the host 1202 receives the user data carried in the transmission initiated by the UE 1206.

One or more of the various embodiments improve the performance of OTT services provided to the UE 1206 using the OTT connection 1250, in which the wireless connection 1270 forms the last segment. More precisely, the teachings of these embodiments may enable network nodes and wireless devices to invalidate at least part of their activities, such as unnecessary measurements, signal monitoring, reporting, and other transmissions, and thus save power. Network nodes and wireless devices may also improve resource utilization by, for example, optimizing PDSCH and/or PUSCH transmission. These, in the end, will increase possibility for network nodes and wireless devices to gain more sleep time and save power. In UL direction, as a result of wireless device's transmission cancellations, the network nodes may create reception gaps during which they can reduce receiver-related activities, for example, utilizing various sleep states depending on gap length, and thereby save energy.

In an example scenario, factory status information may be collected and analyzed by the host 1202. As another example, the host 1202 may process audio and video data which may have been retrieved from a UE for use in creating maps. As another example, the host 1202 may collect and analyze real-time data to assist in controlling vehicle congestion (e.g., controlling traffic lights). As another example, the host 1202 may store surveillance video uploaded by a UE. As another example, the host 1202 may store or control access to media content such as video, audio, VR or AR which it can broadcast, multicast or unicast to UEs. As other examples, the host 1202 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1250 between the host 1202 and UE 1206, in response to variations in the measurement results. The measurement procedure and/or the network functionality for reconfiguring the OTT connection may be implemented in software and hardware of the host 1202 and/or UE 1206. In some embodiments, sensors (not shown) may be deployed in or in association with other devices through which the OTT connection 1250 passes; the sensors may participate in the measurement procedure by supplying values of the monitored quantities exemplified above, or supplying values of other physical quantities from which software may compute or estimate the monitored quantities. The reconfiguring of the OTT connection 1250 may include message format, retransmission settings, preferred routing etc.; the reconfiguring need not directly alter the operation of the network node 1204. Such procedures and functionalities may be known and practiced in the art. In certain embodiments, measurements may involve proprietary UE signaling that facilitates measurements of throughput, propagation times, latency and the like, by the host 1202. The measurements may be implemented in that software causes messages to be transmitted, in particular empty or ‘dummy’ messages, using the OTT connection 1250 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Some example embodiments of the present disclosure are as follows:

Embodiment 1: A method in a wireless device (100), the method comprising invalidating (302) an activity of the wireless device (100) in response to an invalidation configuration being configured for invalidating an activity of the wireless device (100).

Embodiment 2: The method of claim 1, further comprising: receiving a signal explicitly indicating the invalidation configuration, or receiving a defined configuration implying the invalidation configuration.

Embodiment 3: The method of claim 1 or 2, wherein the invalidation configuration is related to at least one of:
periodic or semi-persistent reference signals in downlink and/or uplink,
periodic or semi-persistent grant,
Physical Downlink Control Channel (PDCCH) Monitoring (MO),
search space for scheduling PDCCH,
Physical Random Access Channel (PRACH) access resources,
Physical Uplink Control Channel (PUCCH)/Physical Uplink Shared Channel (PUSCH) resources,
Synchronization Signal Block (SSB), and
System Information Block (SIB).

Embodiment 4: The method of any of claims 1 to 3, wherein the activity comprises at least one of:
reception of periodic or semi-persistent reference signals in downlink and/or uplink,
measurement of reference signals,
reception of scheduling PDCCH,
transmission of periodic or semi-persistent reference signal report,
transmission and/or reception of periodic or semi-persistent uplink grants/downlink assignments,
transmission of a scheduling request,
transmission of a preamble on PRACH,
reception of SSB, either group or individual SSB, reception of SIB, and
transmission/reception of PUCCH/Physical Downlink Shared Channel (PDSCH).

Embodiment 5: The method of any of claims 1 to 3, wherein the invalidation configuration comprises an invalidation duration in which the wireless device refrains from performing the activity, or a reference to one or more of a set of preconfigured invalidation durations, and invalidating the activity of the wireless device comprises refraining from performing the activity for a period according to the invalidation duration.

Embodiment 6: The method of claim 5, wherein the invalidation duration is represented by a preconfigured value in unit of time, or by a relative value which is a multiple of a specific time length, or is numerology dependent or independent.

Embodiment 7: The method of claim 5 or 6, wherein the invalidation duration is defined per activity, or per channel, or per transmission direction, or per SSB, or per signal, or per cell; and the method further comprises, before invalidating the activity of the wireless device, determining whether the invalidation duration is defined for the activity; and invalidating the activity of the wireless device comprises, if it is determined that the invalidation duration is defined for the activity, refraining from performing the activity for a period with respect to a channel, or a transmission direction, or a SSB, or a signal, or a cell according to the invalidation duration.

Embodiment 8: The method of any of claims 5 to 7, wherein the wireless device is informed of the set of preconfigured invalidation durations via a first signaling, and then informed of which invalidation duration from the set is to be currently applied via a second signaling.

Embodiment 9: The method of any of claims 1 to 8, wherein the invalidation configuration comprises an invalidation pattern or a reference to one of a set of preconfigured patterns, which indicates a pattern in which the wireless device invalidates the activity, and invalidating the activity of the wireless device comprises refraining from performing the activity according to the invalidation pattern.

Embodiment 10: The method of claim 9, wherein the invalidation pattern indicates when the wireless device remains performing the activity, or when the wireless device refrains from performing the activity.

Embodiment 11: The method of claim 9 or 10, wherein the invalidation pattern indicates periodicity configured for the activity, and invalidating the activity of the wireless device comprises refraining from performing the activity in a periodic manner according to the periodicity.

Embodiment 12: The method of claim 11, wherein the periodicity is configured as a predefined value in unit of time, or as an integer value which is multiplied with a specific periodicity.

Embodiment 13: The method of any of claims 9 to 12, wherein the periodicity configured in the invalidation pattern overwrites a periodicity originally configured for the activity.

Embodiment 14: The method of any of claims 9 to 13, wherein the invalidation configuration comprises a duration configured to define how long the invalidation pattern should be applied to the activity, and invalidating the activity of the wireless device comprises refraining from performing the activity according to the invalidation pattern for the configured duration.

Embodiment 15: The method of any of claims 1 to 14, wherein the invalidation configuration comprises one or more formats defined through higher layer signaling.

Embodiment 16: The method of any of claims 1 to 15, wherein: the one or more formats are defined as UE specific, group-common, or cell specific, and/or the one or more formats are defined the same or different for different activities, signals, channels, or operations; and invalidating the activity of the wireless device comprises refraining from performing the activity according to the one or more formats.

Embodiment 17: The method of any of claims 1 to 16, wherein the invalidation configuration is configured for specific instances of a recurrent transmission.

Embodiment 18: The method of claim 17, wherein the invalidation configuration is in a form of ssb-PositionsInBurst, called invalidSsb-PositionsInBurst, pointing out one or more instances of the SSBs that are invalidated, or update content of SSBperiodicity or SSBtomeasure without a need for SI update or Radio Resource Control (RRC) reconfiguration.

Embodiment 19: The method of any of claims 17 to 18, wherein the format is a Downlink Control Information (DCI) format or a Medium Access Control Layer-Control Element (MAC-CE) format.

Embodiment 20: The method of any of claims 1 to 19, wherein the invalidation configuration comprises a number of bits that are used in invalidation signaling bitfield.

Embodiment 21: The method of claim 20, wherein the invalidation configuration comprises a length, a location or a size of the bitfield in a DCI format.

Embodiment 22: The method of claim 20 or 21, wherein the number of bits includes a predefined value, or based on a number of durations or patterns included in the invalidation configuration.

Embodiment 23: The method of any of claims 1 to 22, wherein the invalidation configuration comprises a codepoint representation including one or more codepoints for representing whether there is invalidation configuration or not, or the invalidation durations or patterns.

Embodiment 24: The method of claim 23, wherein the number of codepoints is based on a number of durations or patterns included in the invalidation configuration.

Embodiment 25: The method of any of claims 1 to 24, wherein the invalidation configuration comprises one or more codepoints for representing activities or instances of transmission within an activity to be invalidated.

Embodiment 26: The method of any of claims 1 to 25, wherein the invalidation configuration is configured and transmitted through broadcast channel or system information.

Embodiment 27: The method of any of claims 1 to 26, wherein the invalidation configuration comprises a timing indication indicating a timing to apply activity invalidation, and invalidating the activity of the wireless device comprises refraining from performing the activity at the timing indicated by the timing indication.

Embodiment 28: The method of claim 27, wherein refraining from performing the activity at the timing indicated by the timing indication comprises: refraining from performing the activity directly after receiving the invalidation configuration; or refraining from performing the activity at a symbol which is at least P symbols or Q slots after the last symbol of PDCCH containing the invalidation configuration, wherein the values of P and Q are preconfigured, or based on numerology, or configured based on processing capability of the wireless device.

Embodiment 29: The method of any of claims 27 to 28, wherein the timing indication is configured differently per activity, per operation, per channel, per cell, per Bandwidth Part (BWP), per band.

Embodiment 30: The method of any of claims 27 to 29, wherein the timing indication is configured based on a specific reference time in relation to the invalidation configuration.

Embodiment 31: The method of any of claims 1 to 30, wherein the invalidation configuration is configured in a periodic manner, and invalidating the activity of the wireless device comprises: refraining from performing the activity periodically according to the invalidation configuration.

Embodiment 32: The method of claim 31, wherein a period of the invalidation configuration comprises an invalidation interval and a non-invalidation interval defined by one or more offsets from a beginning of a specific period.

Embodiment 33: The method of any of claims 1 to 32, further comprising: resuming the activity of the wireless device in response to a cancellation configuration being configured for canceling the invalidation configuration and resuming the activity.

Embodiment 34: The method of claim 33, wherein the cancellation configuration is represented by a codepoint included in the invalidation configuration, or is configured in a same or different manner as the invalidation configuration; and/or wherein resuming the activity of the wireless device comprises resuming the activity of the wireless device after a predetermined or configured application delay from when the wireless device receives the cancellation configuration.

Embodiment 35: The method of any of claims 1 to 34, further comprising: controlling counting operations of one or more timers included in the wireless device in response to the invalidation configuration being configured.

Embodiment 36: A wireless device (100), comprising: one or more processors (102); and memory (104) storing instructions that, when executed by the one or more processors (102), cause the wireless device (100) to perform a method comprising invalidating (302) an activity of the wireless device (100) in response to an invalidation configuration being configured for invalidating an activity of the wireless device (100).

Embodiment 37: The wireless device of claim 36 wherein the instructions further cause the wireless device to perform the method of any one of claims 2 to 35.

Embodiment 38: A method in a network node (200), the method comprising: informing (402) to a wireless device (100) an invalidation configuration for invalidating an activity of the wireless device (100).

Embodiment 39: The method of claim 38, further comprising: configuring (400) the invalidation configuration.

Embodiment 40: The method of claim 38 or 39, wherein informing the invalidation configuration comprises: transmitting a signal explicitly indicating the invalidation configuration, or transmitting a defined configuration implying the invalidation configuration.

Embodiment 41: The method of any of claims 38 to 40, further comprising: refraining from performing an activity of the network node corresponding to the activity of the wireless device in accordance with the invalidation configuration.

Embodiment 42: The method of any of claims 38 to 41, further comprising: informing to the wireless device a cancellation configuration for canceling the invalidation configuration and resuming the activity; and resuming the activity of the network node according to the cancellation configuration.

Embodiment 43: A network node (200), comprising: one or more processors (202); and memory (204) storing instructions that, when executed by the one or more processors (202), cause the network node (200) to perform a method comprising informing (402) to a wireless device (100) an invalidation configuration for invalidating an activity of the wireless device (100).

Embodiment 44: The network node of claim 43 wherein the instructions further cause the network node to perform the method of any one of claims 39 to 42.

Those skilled in the art will recognize improvements and modifications to the embodiments of the present disclosure. All such improvements and modifications are considered within the scope of the concepts disclosed herein.

1. A method in a wireless device, the method comprising:
receiving a signal explicitly indicating an invalidation configuration for invalidating an activity of the wireless device, or receiving a defined configuration implying the invalidation configuration; and
invalidating the activity of the wireless device in response to the invalidation configuration.

2. The method of claim 1, wherein the invalidation configuration is related to at least one of:
periodic or semi-persistent reference signals in downlink and/or uplink;
periodic or semi-persistent grant;
Physical Downlink Control Channel Monitoring,
search space for scheduling PDCCH;
Physical Random Access Channel access resources;
Physical Uplink Control Channel/Physical Uplink Shared Channel resources;
Synchronization Signal Block;
System Information Block; and
scheduling requests.

3. The method of claim 1, wherein the activity comprises at least one of:
reception of periodic or semi-persistent downlink reference signals;
transmission of periodic or semi-persistent uplink reference signals;
measurement of reference signals;
reception of scheduling Physical Downlink Control Channel;
transmission of a periodic or semi-persistent reference signal report,
reception of periodic or semi-persistent uplink grants and/or downlink assignments;
transmission of a scheduling request;
transmission of a preamble on a Physical Random Access Channel;
reception of either a group or individual Synchronization Signal Block;
reception of a System Information Block; and
Physical Uplink Control Channel transmission; and
Physical Downlink Shared Channel reception.

4. The method of claim 1, wherein:
the invalidation configuration comprises an invalidation duration in which the wireless device refrains from performing the activity, or a reference to one of a set of preconfigured invalidation durations as the invalidation duration; and
invalidating the activity of the wireless device comprises refraining from performing the activity for a period of time according to the invalidation duration.

5. The method of claim 4, wherein the invalidation duration is represented by a preconfigured value in unit of time or by a relative value which is a multiple of a specific time length, or is numerology dependent or independent.

6. The method of claim 4, wherein:
the invalidation duration is defined per activity, or per channel, or per transmission direction, or per Synchronization Signal Block or per signal, or per cell;
the method further comprises, before invalidating the activity of the wireless device, determining whether the invalidation duration is defined for the activity; and
invalidating the activity of the wireless device comprises, if it is determined that the invalidation duration is defined for the activity, refraining from performing the activity for a period of time with respect to a channel, or a transmission direction, or an SSB, or a signal, or a cell according to the invalidation duration.

7. The method of claim 4, wherein:
the invalidation configuration comprises a reference to one of a set of preconfigured invalidation durations as the invalidation duration;
the wireless device is informed of the set of preconfigured invalidation durations via a first signaling, and then informed of the one of the set of preconfigured invalidation durations is the invalidation duration to be currently applied via a second signaling.

8. The method of claim 1, wherein:
the invalidation configuration comprises an invalidation pattern or a reference to one of a set of preconfigured patterns, which indicates a pattern in which the wireless device is to invalidate the activity; and
invalidating the activity of the wireless device comprises refraining from performing the activity according to the invalidation pattern.

9-15. (canceled)

16. The method of claim 1, wherein the invalidation configuration is configured for specific instances of a recurrent transmission.

17. The method of claim 16, wherein the invalidation configuration is in a form of ssb-PositionsInBurst, called invalidSsb-PositionsInBurst, pointing out one or more instances of Synchronization Signal Blocks that are invalidated, or an update to content of SSBperiodicity or SSBtomeasure without a need for a system information update or Radio Resource Control reconfiguration.

18. The method of claim 16, wherein the format is a Downlink Control Information format or a Medium Access Control Layer-Control Element format.

19. The method of claim 1, wherein the invalidation configuration comprises a number of bits that are used in an invalidation signaling bitfield.

20. The method of claim 19, wherein the invalidation configuration comprises a length, a location, or a size of the invalidation signaling bitfield in a DCI format.

21. The method of claim 19, wherein the number of bits includes a predefined value, or is based on a number of durations or patterns included in the invalidation configuration.

22. The method of claim 1, wherein the invalidation configuration comprises a codepoint representation including one or more codepoints for representing whether there is invalidation configuration or not, or the invalidation durations or patterns.

23-25. (canceled)

26. The method of claim 1, wherein:
the invalidation configuration comprises a timing indication indicating a timing to apply activity invalidation; and
invalidating the activity of the wireless device comprises refraining from performing the activity at the timing indicated by the timing indication.

27. The method of claim 26, wherein refraining from performing the activity at the timing indicated by the timing indication comprises:
refraining from performing the activity directly after receiving the invalidation configuration; or
refraining from performing the activity at a symbol which is at least P symbols or Q slots after the last symbol of a Physical Downlink Control Channel containing the invalidation configuration, wherein the values of P and Q are preconfigured, or based on numerology, or configured based on a processing capability of the wireless device.

28. The method of claim 26, wherein the timing indication is configured differently per activity, per operation, per channel, per cell, per Bandwidth Part (BWP) or per band.

29. The method of claim 26, wherein the timing indication is configured based on a specific reference time in relation to the invalidation configuration.

30. The method of claim 1, wherein:
the invalidation configuration is configured in a periodic manner; and
invalidating the activity of the wireless device comprises refraining from performing the activity periodically according to the invalidation configuration.

31-33. (canceled)

34. The method of claim 1, further comprising:
controlling counting operations of one or more timers included in the wireless device in response to the invalidation configuration being configured.

35. A wireless device, comprising:
one or more processors; and
memory storing instructions that, when executed by the one or more processors, cause the wireless device to:
receive a signal explicitly indicating an invalidation configuration for invalidating an activity of the wireless device, or receive a defined configuration implying the invalidation configuration; and
invalidate the activity of the wireless device in response to the invalidation configuration.

36. (canceled)

37. A method in a network node, the method comprising:
sending to a wireless device an invalidation configuration for invalidating an activity of the wireless device.

38-39. (canceled)

42. A network node, comprising:
one or more processors; and
memory storing instructions that, when executed by the one or more processors, cause the network node to perform a method comprising:
transmitting to a wireless device an invalidation configuration for invalidating an activity of the wireless device.

43. (canceled)
